(19) United States
(12) Patent Application Publication
(10) Pub. No.: US 2021/0365963 A1
(43) Pub. Date: Nov. 25, 2021

(54) TARGET CUSTOMER IDENTIFICATION METHOD AND DEVICE, ELECTRONIC DEVICE AND MEDIUM

(71) Applicant: PING AN TECHNOLOGY (SHENZHEN) CO., LTD., Shenzhen, Guangdong (CN)

(72) Inventors: Fang LI, Shenzhen (CN); Jianming WANG, Shenzhen (CN); Jing XIAO, Shenzhen (CN)

(21) Appl. No.: 16/316,028

(22) PCT Filed: Sep. 29, 2017
(86) PCT No.: PCT/CN2017/104490

§ 371 Date: Jan. 7, 2019

(30) Foreign Application Priority Data
Aug. 24, 2017 (CN) 201710736127.3

(51) Int. Cl. G06Q 30/02; G06Q 10/06; G06N 20/20

(52) U.S. Cl. CPC G06Q 30/0202; G06Q 30/0201; G06Q 10/06398; G06Q 10/1091; G06Q 30/0255; G06N 20/20; G06Q 30/0246

(57) ABSTRACT

The present solution provides a target customer identification method and a device, an electronic device and a medium, which is applicable to the field of information processing. The method includes: obtaining personal characteristics data of potential customers; calculating a customer conversion rate of a telephone sales representative during each working time period according to the total number of customers who have made a transaction and the total number of marketing target customers of the telephone sales representative in each of working time periods; inputting the customer conversion rate of the telephone sales representative in the current working time period and the personal characteristics data of the potential customers into a pre-established random forest model to output product purchase probabilities of the potential customers; and determining a potential customer whose product purchase probability is greater than a preset threshold as a target customer of the telephone sales representative in the current working time period. In the present solution, the consideration factor of the real-time marketing capability of the telephone sales representative is added, so that the telephone sales representative can accurately find out the target customers at the current time, thereby improving customer conversion rate, marketing efficiency and target customer identification accuracy.

The present application claims the priority of Chinese Patent Application with the Application No. 201710736127.3, entitled “TARGET CUSTOMER IDENTIFICATION METHOD AND TERMINAL DEVICE”, and filed with State Intellectual Property Office on Aug. 24, 2017, the contents of which are incorporated herein by reference in its entirety.

### TECHNICAL FIELD

The present application relates to the field of information processing, and particularly, to a target customer identification method and a device, an electronic device and a medium.

### BACKGROUND

Currently, product marketing methods include telemarketing, email marketing, SMS marketing, etc. Telemarketing (TMK) is a technique in which telephones are used to achieve the expansion of the customer base in a planned, organized and efficient manner. In order to avoid a situation that sales staff of telemarketing can only randomly make a large number of calls, and rely on luck to sell products to various phone receivers, at present, major companies have begun work on achieving personalized precision marketing. Specifically, through in-depth analysis of the collected personal characteristics data of each customer, the different consumption characteristics of different customers are determined, thus, a customer is determined as a target customer when the sales product and the customer's consumption characteristics are well matched and telephone sales representatives are conducted to make a telemarketing call to the target customer. Therefore, it can be ensured accordingly that after each telemarketing call, there is a greater probability that the customer will be converted into the actual customer who has made a transaction who purchases the product, thereby improving a marketing efficiency.

However, the existing target customer identification method can only evaluate whether a customer is a target customer based on the customer's personal characteristics data, it only needs to consider a single factor, such that the target customer identification accuracy is lower.

### SUMMARY

In view of this, an embodiment of the present application provides a target customer identification method and device, an electronic device and a medium, which aims at solving a problem in the related art that the target customer identification accuracy is low and it is difficult to further screen out customers having higher product purchase probability.

A first aspect of an embodiment of the present application provides a target customer identification method, including:

obtaining personal characteristics data of potential customers;

calculating, in each of working time periods, a customer conversion rate of a telephone sales representative according to the total number of customers who have made a transaction and the total number of marketing target customers of the telephone sales representative, in each of the working time periods;

inputting the customer conversion rate of the telephone sales representative in the current working time period and the personal characteristics data of the potential customers into a pre-established random forest model to output product purchase probabilities of the potential customers; and

determining a potential customer whose product purchase probability is greater than a preset threshold as a target customer of the telephone sales representative in the current working time period.

A second aspect of an embodiment of the present application provides a target customer identification device, including:

a first obtaining module configured to obtain personal characteristics data of potential customers;

a calculation module configured to, in each of the working time periods, calculate the customer conversion rate of a telephone sales representative in each of the working time periods according to the total number of customers who have made a transaction and the total number of marketing target customers of the telephone sales representative;

a first output module configured to input the customer conversion rate of the telephone sales representative in a current working time period and personal characteristics data of the potential customers into a pre-established random forest model to output product purchase probabilities of the potential customers; and a determining module configured to determine the potential customer whose product purchase probability is greater than a preset threshold as a target customer of the telephone sales representative in the current working time period.

A third aspect of an embodiment of the present application provides an electronic device including a memory, a processor and a computer readable instruction stored on the memory and executable on the processor, where when the processor executes the computer readable instruction, the steps of the target customer identification method as provided by the aforementioned first aspect are implemented.

A fourth aspect of an embodiment of the present application provides a computer readable storage medium storing a computer readable instruction, and when the computer readable instruction is executed by at least one processor, the steps of the target customer identification method as provided by the aforementioned first aspect are implemented.

In an embodiment of the present application, by obtaining the customer conversion rate of a telephone sales representative in the current working time period, the marketing capability of the telephone sales representative at the current time can be quantified; by inputting the customer conversion rate of the telephone sales representative and personal characteristics data of potential customers into a pre-established random forest model, the product purchase probability of the potential customers can be predicted based on the condition factors of a marketing party and a marketed party. The potential customers can be determined as target customers of the telephone sales representative at the current time only when the product purchase probability is greater than a preset threshold, such that the telephone sales representative can accurately find out the target customer to whom should be marketed, and the customer conversion rate and marketing efficiency are improved; on the basis of evaluating whether the customer is a target customer only according to personal characteristics data of the customer in the prior art, the recognition accuracy of the target customer is improved by adding the consideration factor of the marketing capability of the telephone sales representative, due to the fact that the marketing capability of the telephone sales representative has a great influence on whether the customer purchase the product successfully. Therefore, the target customer who has a higher product purchase probability can be further screened out based on the method provided by the embodiment of the present application.

### BRIEF DESCRIPTION OF DRAWINGS

In order to illustrate the technical solutions in the embodiments of the present application more clearly, the accompanying drawings used for describing the embodiments or the prior art will be briefly described below. Apparently, the accompanying drawings in the following description are only some embodiments of the present application. For the ordinarily skilled one in the art, other accompanying drawings may also be obtained without paying creative labor.

FIG. 1 illustrates an implementation flowchart of a target customer identification method according to Embodiment I of the present application;

FIG. 2 illustrates an implementation flowchart of a target customer identification method according to Embodiment II of the present application;

FIG. 3 illustrates an implementation flowchart of a target customer identification method according to Embodiment III of the present application;

FIG. 4 illustrates a specific implementation flowchart of step S103 of a target customer identification method according to Embodiment 4 of the present application;

FIG. 5 illustrates an implementation flowchart of a target customer identification method according to Embodiment V of the present application;

FIG. 6 illustrates a structure diagram of a target customer identification device according to Embodiment VI of the present application;

FIG. 7 illustrates a structure diagram of a target customer identification device according to Embodiment VI of the present application;

FIG. 8 illustrates a structure diagram of a target customer identification device according to Embodiment VI of the present application;

FIG. 9 illustrates a structure diagram of a target customer identification device according to Embodiment VI of the present application; and

FIG. 10 illustrates a schematic diagram of an electronic apparatus according to Embodiment VII of the present application.

### DESCRIPTION OF EMBODIMENTS

In the following description, in order to describe but not intended to limit, concrete details such as specific system structure, technique, and so on are proposed, thereby facilitating comprehensive understanding of the embodiments of the present application. However, it will be apparent to the ordinarily skilled one in the art that, the present application can also be implemented in some other embodiments without these concrete details. In some other conditions, detailed explanations of method, circuit, device and system well known to the public are omitted, so that unnecessary details can be prevented from obstructing the description of the present application.

### Embodiment I

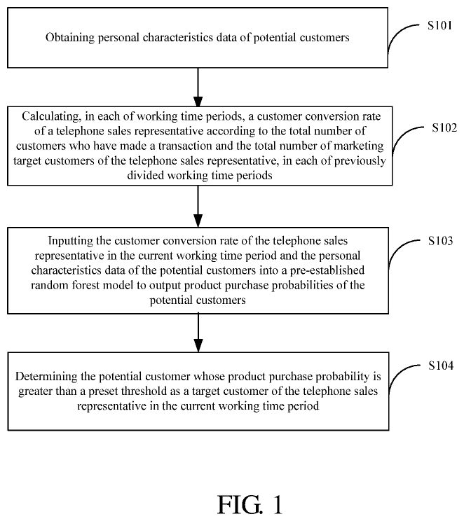

FIG. 1 illustrates an implementation flowchart of a target customer identification method according to an embodiment of the present application, and the method includes steps S101 to S104. The specific implementation principles of each step are as follows:

Step S101: obtaining personal characteristics data of potential customers.

The potential customers refer to customers to be developed who have the possibility to purchase telemarketing products, a target customer who has a higher product purchase probability and need to be further marketed by phone can be digged out from the potential customers. Under the condition that telemarketing products and telemarketing services meet the needs of the potential customers, the potential customers can be converted into actual customers who have made a transaction who purchase the products. In this case, the telemarketing products refer to products recommended by telephone sales representatives to the customers by means of telephone communication, including but not limited to insurance products and credit products and other financial products.

In an embodiment of the present application, a customer list and personal characteristics data of the potential customers are obtained through various ways. For example, the customer list and personal characteristics data are obtained from historical customer information of other types of financial products, hotline service desks, or consulting customer information received by business halls. In this case, the personal characteristics data includes, but is not limited to, age, income, hobbies, education, historical sum of consumption of financial products, and paid life insurance premiums. In this case, each personal characteristics data is an attribute feature.

Step S102: calculating, in each of working time periods, a customer conversion rate of a telephone sales representative according to the total number of customers who have made a transaction and the total number of marketing target customers of the telephone sales representative in each of the working time periods;

The working time period of the telephone sales representative in one day is divided, so that a plurality of working time periods is obtained. For example, if the working time period of the telephone sales representative is 10:00 to 18:00, and every two hours is a working time period, then 4 working time periods can be obtained, which are respectively the first working time period 10:00-12:00, the second working time period 12:01-14:00, the third working time period 14:01-16:00, and the fourth working time period 16:01-18:00.

During each working time period, the telephone sales representative will conduct telemarketing to a plurality of customers, and the total number of customers contacted by the telephone sales representative during the working time period is the total number of marketing target customers. After the marketing of the telephone sales representative, if the customer contacted by the telephone sales representative is subjected to marketing successfully and then purchases the telemarketing product, the customer is converted into a customer who has made a transaction. During a working time period, the total number of customers who have made a transaction of the telephone sales representative is the total number of the aforementioned customers who have made a transaction.

According to the historical marketing data of the telephone sales representative corresponding to each working time period, the average number of customers who have made a transaction and the total number of marketing target customers of the telephone sales representative in the working time period are obtained, and the ratio of the total number of customers who have made a transaction and the total number of marketing target customers is output as the customer conversion rate of the telephone sales representative in the working time period. It can be seen that the customer conversion rate also represents a marketing success rate of the telephone sales representative during a fixed working time period.

Step S103: inputting the customer conversion rate of the telephone sales representative in the current working time period and the personal characteristics data of the potential customers into a pre-established random forest model to output product purchase probabilities of the potential customers.

Before the telephone sales representative conducts telemarketing, the target customers that the telephone sales representative needs to contact at the current time needs to be determined. A working time period which includes current time is determined according to the division manner of the working time period in step S102. Based on the customer conversion rate of the telephone sales representative for each working time period calculated by the aforementioned step S102, the customer conversion rate of the telephone sales representative in the current working time period is obtained by matching.

For example, if the current time is 14:37, then, the current working time period can be determined to be the third working time period (14:01-16:00) according to the working time period division manner in the example described above. At this time, the customer conversion rate of the telephone sales representative during the third working time period is obtained.

In the embodiment of the present application, a pre-trained random forest model is obtained. The random forest model includes a plurality of decision trees, each of the plurality of decision trees is used for classification and selection based on input parameters. After the classification and selection results of each of the decision trees are statistically summarized, a final output parameter of the random forest model is obtained. In this case, the input parameters are the customer conversion rate of the telephone sales representative in the current working time period and the personal characteristics data of the current potential customers. The output parameters are the product purchase probabilities of the potential customers.

Step S104: determining a potential customer whose product purchase probability is greater than a preset threshold as a target customer of the telephone sales representative in the current working time period.

As for a certain telephone sales representative, if the product purchase probability of the potential customer at the current time is lower than the preset threshold, then, it indicates that even if the telephone sales representative makes a telemarketing on the customer, it is difficult to convert the potential customer into a customer who has made a transaction. Therefore, in order to improve the marketing efficiency of the telephone sales representative, only a potential customer whose product purchase probability is greater than the preset threshold is determined as a target customer. By recommending the determined target customers to the telephone sales representative, the telephone sales representative can make a telemarketing on the target customer who has a higher product purchase probability within limited time, thereby improving the customer conversion rate to the maximum extent.

In an embodiment of the present application, by obtaining the customer conversion rate of a telephone sales representative in the current working time period, the marketing capability of the telephone sales representative at the current time can be quantified; by inputting the customer conversion rate of the telephone sales representative and personal characteristics data of potential customers into a pre-established random forest model, the product purchase probability of the potential customers can be predicted based on the condition factors of both a marketing party and a marketed party. The potential customers can be determined as target customers of the telephone sales representative at the current time only when the product purchase probability is greater than a preset threshold, such that the telephone sales representative can accurately find out the customer who should be marketed, both the customer conversion rate and the marketing efficiency are improved; on the basis of evaluating whether the customer is a target customer only according to personal characteristics data of the customer in the prior art, an accuracy of recognition of the target customer is improved by adding the consideration factor of the marketing capability of the telephone sales representative, due to the fact that the marketing capability of the telephone sales representative has a great influence on whether the customer purchase the product successfully. Therefore, the target customer who has a higher product purchase probability can be further screened out based on the method provided by the embodiment of the present application.

### Embodiment II

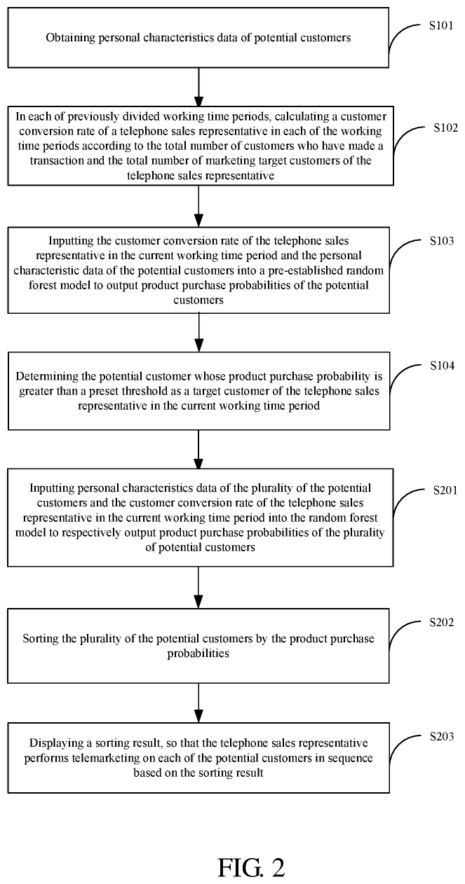

As an embodiment of the present application, on the basis of the above Embodiment I, this embodiment further limits the displaying mode of target customers. As shown in FIG. 2, the above target customer identification method further includes:

Step S201: inputting personal characteristics data of a plurality of potential customers and a customer conversion rate of a telephone sales representative in the current working time period into a random forest model to respectively output product purchase probabilities of the plurality of potential customers.

For the previously acquired personal characteristics data of the plurality of potential customers, after the personal characteristics data of one of the potential customers and the customer conversion rate of the telephone sales representative in the current working time period are input into the random forest model, the personal characteristics data of the next potential customer and the customer conversion rate of the telephone sales representative in the current working time period are input. By analogy, until input of the previously acquired personal characteristics data of each of the potential customers is completed.

Since the potential purchase probability of each of the potential customers can be output after the personal characteristics data of each of the potential customers and the customer conversion rate of the telephone sales representative are identified and processed by random forest model, the product purchase probability of each of the potential customers can be sequentially output after the personal characteristics data of the plurality of potential customers and the customer conversion rate of the telephone sales representative are input into the random forest model sequentially.

Step S202: sorting the plurality of potential customers by the product purchase probabilities.

Based on the plurality of product purchase probabilities of the plurality of potential customers, the potential customers are sorted by the values of the product purchase probabilities, such that a potential customer who has a higher product purchase probability is ranked ahead of a potential customer who has a lower product purchase probability.

Step S203: displaying the sorting result, so that the telephone sales representative performs telemarketing on each of the potential customers in sequence based on the sorting results.

Displaying the sorting result of the aforementioned plurality of potential customers specifically includes: generating a customer list including a sorting order of the plurality of potential customers, wherein the customer list includes contact information of each of the potential customers; and displaying the customer list on a terminal interface of the telephone sales representative.

The telephone sales representative conducts telemarketing on each of the potential customers in sequence based on the customer list displayed on the terminal interface of the telephone sales representative and the contact information of each of the potential customers in the customer list.

In the embodiment of the present application, by inputting the personal characteristics data of the plurality of potential customers into the random forest model, batch output of the product purchasing probabilities of the plurality of potential customers is implemented; each of the potential customers is sorted and displayed based on the value of the product purchase probabilities. In this way, the telephone sales representative can perform the telemarketing operations in sequence according to the sorting order of the customers. Since the potential customers who has a higher rank have greater possibility to be converted into customers who have made a transaction, by marketing each of the potential customers according to the sorting order, it is guaranteed that the telephone sales representative can complete his/her own task scalar in the shortest possible time, so that a marketing efficiency is improved.

### Embodiment III

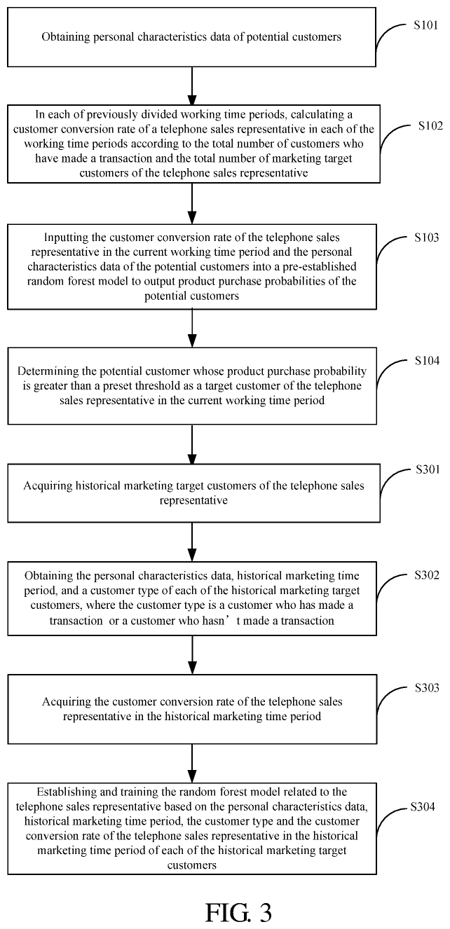

As an embodiment of the present application, on the basis of each of the foregoing embodiments, the manner of obtaining training sample data of the random forest model is further limited. As shown in FIG. 3, the above target customer identification method further includes:

step S301: acquiring historical marketing target customers of the telephone sales representative;

step S302: obtaining the personal characteristics data, historical marketing time period, and a customer type of each of the historical marketing target customers, where the customer type is a customer who has made a transaction or a customer who hasn't made a transaction.

Each of customers who are marketed by the telephone sales representative and the marketing information related to the customers are recorded in a database. Before the random forest model related to a telephone sales representative is trained, historical marketing data of the telephone sales representative is retrieved from a database, and the historical marketing data includes each historical marketing target customer who has been marketed by the telephone sales representative and personal characteristics data and customer type of each historical marketing target customer and the historical marketing time when the historical marketing target customer is marketed by phone. According to the aforementioned preset working time period division manner, a historical marketing time period corresponding to each historical marketing time is determined.

In this case, the aforementioned customer type is a customer who has made a transaction or a customer who hasn't made a transaction. That is, it depends on whether the customer who is marketed by the telephone sales representative has finally purchased the telemarketing product. If so, the historical marketing target customer is the customer who has made a transaction, and if not, the historical marketing target customer is a customer who hasn't made a transaction.

Step S303: acquiring the customer conversion rate of the telephone sales representative for the historical marketing time period.

Since the customer conversion rate of each working time period can be obtained by the aforementioned step S102, according to a historical marketing time period corresponding to the historical marketing time of different historical marketing target customers, the customer conversion rate of the telephone sales representative in each historical marketing time period can be determined.

Step S304: establishing and training the random forest model related to the telephone sales representative based on the personal characteristics data, historical marketing time period, the customer type and the customer conversion rate of the telephone sales representative for the historical marketing time period of each of the historical marketing target customers.

A plurality of training sample data is input into a pre-built random forest model. Each training sample data includes various personal characteristics data, historical marketing time period and customer type of a historical marketing target customer and the customer conversion rate of the historical marketing target customer of the telephone sales representative for the historical marketing time period.

Based on each received training sample data, model parameters in the random forest model are adjusted. Specifically, in the received N training sample data, the random sampling with replacement is repeatedly performed to take the extracted M (0<M<N, and M is an integer) training sample data as a new training sample set. Based on the new training sample set, K (K is an integer greater than 1) decision trees for classification are generated. In this case, decision trees include binary trees as well as non-binary trees.

Since a model parameter adjustment method of the random forest model is known in the art, it will not be discussed in detail any more.

In the embodiment of the present application, the historical marketing target customers of the telephone sales representative are obtained, and personal characteristics data, historical marketing time period and customer type of each historical marketing target customer and the customer conversion rate of historical marketing target customer of the telephone sales representative for the historical marketing time period are taken as training sample data of the random forest model, so that the random forest model can be accurately trained based on the positive and negative samples of the customers who have made a transaction and the customers who have not made a transaction, which ensures that the trained random forest model can accurately estimate the product purchase probabilities of the potential customers according to the personal characteristics data of the input potential customers and the real-time customer conversion rate of the telephone sales representative.

### Embodiment IV

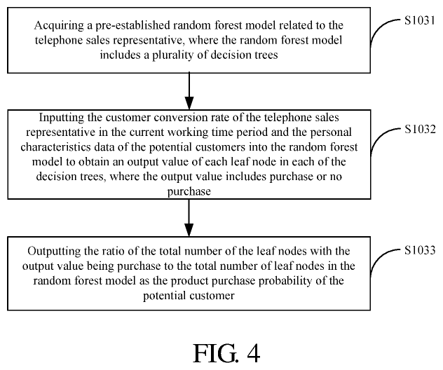

As an embodiment of the present application, as shown in FIG. 4, the foregoing step S103 specifically includes:

Step S1031: acquiring a pre-established random forest model related to the telephone sales representative, where the random forest model includes a plurality of decision trees.

Step S1032: inputting the customer conversion rate of the telephone sales representative in the current working time period and the personal characteristics data of the potential customers into the random forest model to obtain an output value of each leaf node in each of the decision trees, where the output value includes purchase or no purchase.

S1033: outputting the ratio of the total number of the leaf nodes with the output value being purchase to the total number of leaf nodes in the random forest model as the product purchase probability of the potential customer.

When it is determined whether a potential customer is a target customer, it is necessary to accurately determine whether the potential customer is a target customer of a specified telephone sales representative. Therefore, in the embodiment of the present application, the pre-built and trained random forest model is a random forest model related to the specified telephone sales representative. In this case, the trained random forest model includes a plurality of decision trees for classification. Each leaf node in each decision tree corresponds to an attribute feature, and the output value of the leaf node represents a classification option value obtained by classifying an attribute feature of the input potential customer through a branch where the leaf node is located. The attribute features include historical marketing time period of the input potential customer, various personal characteristics data, and the customer conversion rate of the telephone sales representative for the historical marketing time period.

If the output value of a leaf node is 1, then it indicates that the input potential customer will purchase the telemarketing product in the consideration factor of the attribute feature corresponding to the leaf node; if the output value of a leaf node is 0, then it indicates that the input potential customers will not purchase the telemarketing products in the consideration factor of the attribute feature corresponding to the leaf node.

After various attribute features of a potential customer are input into the random forest model, the output value of each leaf node in the random forest model can be obtained. The output value of each leaf node is summarized to be determined as the total number of leaf nodes of telemarketing products which will be purchased by the potential customer. The ratio of this total number to the total number of the leaf nodes in the random forest model is determined as the product purchase probability of the potential customer.

In the embodiment of the present application, by counting the total number of leaf nodes with the output value being purchase, the product purchase status of the potential customers on their respective attribute features can be predicted; by calculating the ratio of the total number of the leaf nodes with the output value being purchase to the total number of leaf nodes in the random forest model, the product purchase status of the potential customer on each attribute feature can be synthesized to determine the overall product purchase probability of the potential customer, and the prediction accuracy of the product purchase probability is improved.

### Embodiment V

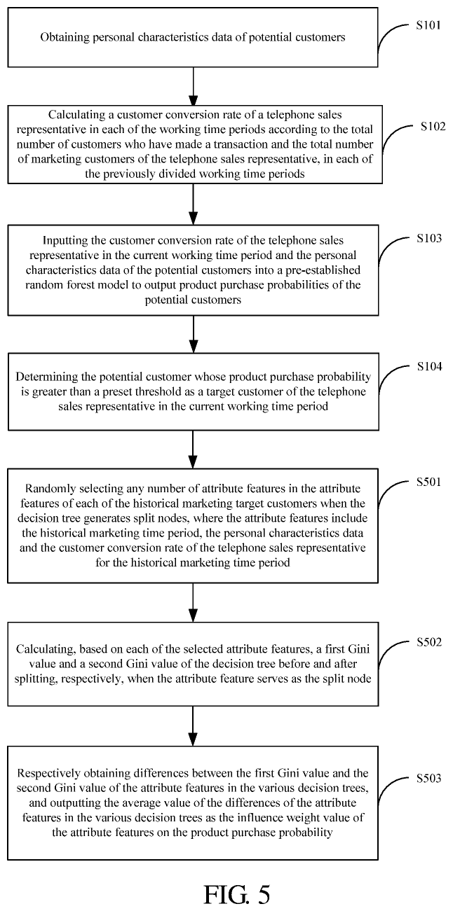

As an embodiment of the present application, on the basis of the aforementioned Embodiment IV, this embodiment further limits the influence weight values of different types of attribute features. As shown in FIG. 5, the above target customer identification method further includes:

step S501: when the decision tree generates split nodes, randomly selecting any number of attribute features in the attribute features of each of the historical marketing target customer, where the attribute features include the historical marketing time period, the personal characteristics data and the customer conversion rate of the telephone sales representative for the historical marketing time period;

step S502: calculating, based on each of the selected attribute features, a first Gini value and a second Gini value of the decision tree before and after splitting, respectively, when the attribute feature serves as the split node;

step S503: respectively obtaining differences between the first Gini value and the second Gini value of the attribute features in the various decision trees, and outputting the average value of the differences of the attribute features in the various decision trees as the influence weight value of the attribute feature on the product purchase probability.

After Q attribute features related to potential customers are input into each decision tree of the random forest model, the decision tree needs to randomly select q (0<q<Q, and q and Q are integers) attribute features therefrom, and the q selected attribute features are analyzed, to determine an attribute feature as a split node from the q attribute features.

If a certain attribute feature is used as the split node, the potential customers whose attribute features are greater than the preset threshold are classified into one category, and the potential customers whose attribute features are less than the preset threshold are classified into another category. Based on the classification result of each potential customer and the actual customer type corresponding to the potential customer, the classification error size is calculated, so as to determine the split purity of the attribute feature. When the split purity is smaller, it indicates the classification accuracy of the decision tree for potential customer is higher.

In the embodiment of the present application, the Gini value is used to measure the split purity of the split node. In the q attribute features selected every time, the Gini values of each of the attribute features after used as a split node is obtained, and an attribute feature with the smallest Gini value is determined as the split node at the current time. In the decision tree of the lower level, the step of randomly selecting q attribute features among the Q attribute features related to the potential customers is executed again, to determine the split nodes of each level until the finally obtained Gini value is lower than the preset threshold value, such as 0.1, and then the generation of the split node of the lower level is stopped.

In each decision tree, supposing that each of the selected attribute features can respectively be used as a split node, the Gini value of each attribute feature before splitting is calculated, and the Gini value of each attribute feature after splitting is calculated. The differences between the Gini values of each of the attribute features in each of the decision trees before and after the splitting are obtained.

The average value of the differences of the same attribute feature in different decision trees is output as the influence weight value of the attribute feature on the potential customer's product purchase probability in the current working time period.

For example, if the random forest model includes two decision trees, and for the attribute feature of the potential customer's income level, in a decision tree 1, the Gini value before the splitting is a1, and the Gini value after the splitting is b1; in a decision tree 2, the Gini value before splitting is a2, and the Gini value after splitting is b2. For the attribute feature of the potential customer's life insurance delivery premium, in the decision tree 1, the Gini value before splitting is a3, and the Gini value after splitting is b3; in the decision tree 2, the Gini value before splitting is a4, and the Gini value after splitting is b4; then the influence weight value of the income level on the potential customer's product purchase probability is [(a1−b1)+(a2−b2)]/2, and the influence weight value of the life insurance delivery premiums on the potential customer's product purchase probability is [(a3−b3)+(a4−b4)]/2.

In the embodiment of the present application, when the decision tree generates split nodes, the Gini value is determined by randomly selecting a plurality of attribute features from all the attribute features of the potential customer, and one attribute feature having the smallest Gini value after splitting is determined as a split node, so that each generated split node can prevent over-fitting, thereby improving the classification accuracy of potential customers obtained by each split node. By outputting the average value of the differences between the Gini values in each decision tree before and after splitting as the influence weight value of the attribute feature on the potential customer's product purchase probability, the telephone sales representative can know which attribute feature has a larger influence weight on the target customer identification result, so that it is possible to perform relatively fast and accurate identification of the target customer based on the attribute features with large influence weights when a list of potential customers that have not been identified by the random forest model is obtained in the future.

It should be understood that the size of the serial numbers of the steps in the above embodiments does not mean the order of execution. The order of execution of each process should be determined by its function and internal logic, and should not be interpreted as limiting the implementation process of the embodiments of the present application.

### Embodiment VI

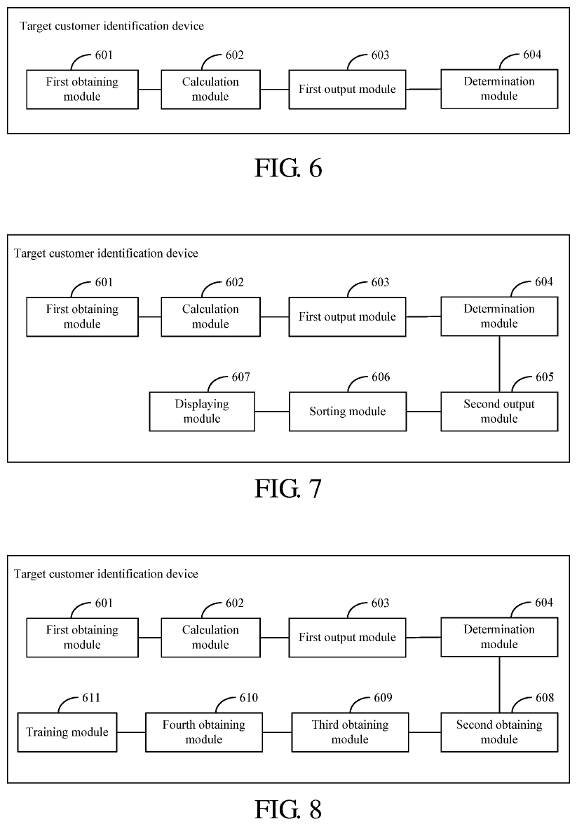

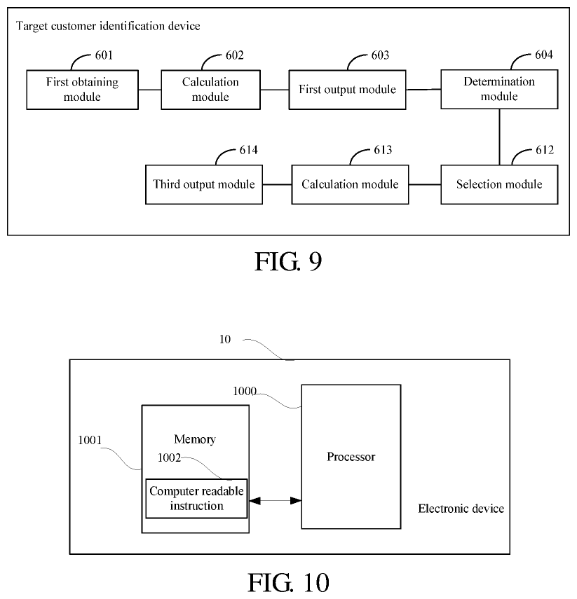

Corresponding to the target customer identification method according to the above embodiments, FIG. 6 illustrates a structural diagram of a target customer identification device according to an embodiment of the present application. For the convenience in description, only parts related to this embodiment are shown.

Referring to FIG. 6, the device includes:

a first obtaining module 601 configured to obtain personal characteristics data of potential customers;

a calculation module 602 configured to calculate the customer conversion rate of a telephone sales representative in each of the working time periods according to the total number of customers who have made a transaction and the total number of marketing target customers of the telephone sales representative, in each of the working time periods;

a first output module 603 configured to input the customer conversion rate of the telephone sales representative in the current working time period and personal characteristics data of the potential customers into a pre-established random forest model to output product purchase probabilities of the potential customers; and

a determining module 604 configured to determine the potential customer whose product purchase probability is greater than a preset threshold as a target customer of the telephone sales representative in the current working time period.

Optionally, as shown in FIG. 7, the device further includes:

a second output module 605 configured to input personal characteristics data of the plurality of the potential customers and the customer conversion rate of the telephone sales representative in the current working time period into the random forest model to respectively output product purchase probabilities of the plurality of potential customers;

a sorting module 606 configured to sort the plurality of potential customers by the product purchase probabilities; and

a displaying module 607 configured to display the sorting result, so that the telephone sales representative performs telemarketing on each of the potential customers in sequence based on the sorting result.

Optionally, as shown in FIG. 8, the device further includes:

a second obtaining module 608 configured to obtain historical marketing target customers of the telephone sales representative;

a third obtaining module 609 configured to obtain the personal characteristics data, historical marketing time period, and customer type of each of the historical marketing target customers, where the customer type is a customer who has made a transaction or a customer who hasn't made a transaction;

a fourth obtaining module 610 configured to acquire the customer conversion rate of the telephone sales representative for the historical marketing time period; and

a training module 611 configured to establish and train the random forest model related to the telephone sales representative based on the personal characteristics data, historical marketing time period and customer type of each of the historical marketing target customer and the customer conversion rate of the telephone sales representative for the historical marketing time period.

Optionally, the first output module 603 includes:

an obtaining sub-module configured to acquire a pre-established random forest model related to the telephone sales representative, where the random forest model includes a plurality of decision trees;

an input sub-module configured to input the customer conversion rate of the telephone sales representative in the current working time period and personal characteristics data of the potential customers into the random forest model to obtain an output value of each leaf node in each of the decision trees, where the output value includes purchase or no purchase; and

an output sub-module configured to output the ratio of the total number of the leaf nodes with the output value being purchase to the total number of leaf nodes in the random forest model as the product purchase probability of the potential customer.

Optionally, the device further includes:

a selection module 612 configured to, when the decision tree generates split nodes, randomly select any number of attribute features in the attribute features of each of the historical marketing target customer, where the attribute features include the historical marketing time period, the personal characteristics data and the customer conversion rate of the telephone sales representative for the historical marketing time period;

a calculation module 613 configured to calculate, based on each of the selected attribute features, a first Gini value and a second Gini value of the decision tree before and after splitting, respectively, when the attribute feature serves as the split node; and

a third output module 614 configured to respectively obtain differences between the first Gini value and the second Gini value of the attribute features in the various decision trees, and output the average value of the differences of the attribute features in the various decision trees as the influence weight value of the attribute feature on the product purchase probability.

In an embodiment of the present application, by obtaining the customer conversion rate of a telephone sales representative in the current working time period, the marketing capability of the telephone sales representative at the current time can be quantified; by inputting the customer conversion rate of the telephone sales representative and personal characteristics data of potential customers into a pre-established random forest model, the product purchase probability of the potential customers can be predicted based on the condition factors of a marketing party and a marketed party. The potential customers can be determined as target customers of the telephone sales representative at the current time only when the product purchase probability is greater than a preset threshold, so that the telephone sales representative can accurately find out the customer who should be marketed, and the customer conversion rate and marketing efficiency are improved; on the basis of evaluating whether the customer is a target customer only according to personal characteristics data of the customer in the prior art, the recognition accuracy of the target customer is improved by adding the consideration factor of the marketing capability of the telephone sales representative, due to the fact that the marketing capability of the telephone sales representative has a great influence on whether the customer purchase the product successfully. Therefore, the target customer who has a higher product purchase probability can be further screened based on the method provided by the embodiment of the present application.

### Embodiment VII

FIG. 10 is a schematic diagram of an electronic device according to an embodiment of the present application. As shown in FIG. 10, the electronic device 10 of this embodiment includes a processor 1000, a memory 1001 and computer readable instructions 1002 stored in the memory 1001 and executable on the processor 1000, such as target customer identification readable instructions. When the processor 1000 executes the computer readable instructions 1002, the steps in each of the foregoing embodiments of the target customer identification method, such as steps 101 to 104 shown in FIG. 1, are implemented. Alternatively, when the processor 1000 implements the computer readable instructions 1002, functions of each module/unit in the various device embodiments described above, such as the functions of the modules 601 to 604 shown in FIG. 6, are implemented.

Illustratively, the computer readable instructions 1002 can be partitioned into one or more modules/units that are stored in the memory 1001 and executed by the processor 1000, to complete the present application. The one or more modules/units may be a series of computer readable instruction segments capable of performing a particular function, and the instruction segments are used for describing the execution process of the computer readable instructions 1002 in the electronic apparatus 10.

The electronic apparatus 10 can be a computing device such as a desk computer, a notebook, a palmtop computer, and a cloud server. The electronic device may include, but is not limited to, the processor 1000, and the memory 1001. It will be understood by ordinarily skilled one in the art that FIG. 10 is merely an example of the electronic apparatus 10 and does not constitute as a limitation to the electronic device 10, and may include more or less components than those illustrated, or combine some components, or different components. For example, the electronic device may further include an input/output device, a network access device, a bus, and the like.

The processor 1000 may be a central processing unit (CPU), or may be other general-purpose processors, a digital signal processor (DSP), an application specific integrated circuit (ASIC), a field-programmable gate array (FPGA) or other programmable logic devices, discrete gates or transistor logic devices, discrete hardware components, etc. The general-purpose processor may be a microprocessor or the processor or any conventional processor or the like.

The memory 1001 may be an internal storage unit of the electronic apparatus 10, such as a hard disk or a memory of the electronic apparatus 10. The memory 1001 may also be an external storage device of the electronic apparatus 10, such as, a plug-in hard disk disposed on the electronic apparatus 10, a smart memory card (SMC), a secure digital (SD) card, and a flash card. Further, the memory 1001 may also include both an internal storage unit of the electronic apparatus 10 and an external storage device. The memory 1001 is configured to store the computer readable instructions and other readable instructions and data required by the electronic apparatus. The memory 1001 may also be used to temporarily store data that has been output or is about to be output.

In addition, each functional unit in each embodiment of the present application may be integrated into one processing unit, or each unit may exist physically separately, or two or more units may be integrated into one unit. The integrated units mentioned above can be implemented in the form of hardware or in the form of a software functional unit.

When the integrated unit is implemented in the form of a software functional unit and sold or used as an independent product, the integrated unit may be stored in a computer readable storage medium. Based on such understanding, the technical solutions of the present application essentially, or the part contributing to the prior art, or all or a part of the technical solutions may be implemented in the form of a software product. The software product is stored in a storage medium and includes a plurality of instructions for instructing a computer device (which may be a personal computer, a server, a network device, etc.) to perform all or some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

As stated above, the foregoing embodiments are merely used to explain the technical solutions of the present application, and are not intended to limit the technical solutions. Although the present application has been described in detail with reference to the foregoing embodiments, the ordinarily skilled one in the art should understand that the technical solutions described in the foregoing embodiments can still be modified, or equivalent replacement can be made to some of the technical features. Moreover, these modifications or substitutions do not make the essences of corresponding technical solutions depart from the spirit and the scope of the technical solutions of the embodiments of the present application.

1. A target customer identification method, comprising:
obtaining personal characteristics data of potential customers;
respectively calculating a customer conversion rate of a telephone sales representative in each of working time periods according to the total number of customers who have made a transaction and the total number of marketing target customers of the telephone sales representative, in each of previously divided working time periods;
inputting the customer conversion rate of the telephone sales representative in the current working time period and the personal characteristics data of the potential customers into a pre-established random forest model to output a product purchase probability of the potential customers; and
determining a potential customer whose product purchase probability is greater than a preset threshold as a target customer of the telephone sales representative in the current working time period.

2. The target customer identification method according to claim 1, further comprising:
inputting personal characteristics data of a plurality of potential customers and the customer conversion rate of the telephone sales representative in the current working time period into the random forest model to respectively output product purchase probabilities of the plurality of potential customers;
sorting the plurality of potential customers by the product purchase probabilities; and
displaying a sorting result, so that the telephone sales representative performs telemarketing on the potential customers in sequence based on the sorting result.

3. The target customer identification method according to claim 1, further comprising:
acquiring historical marketing target customers of the telephone sales representative;
obtaining the personal characteristics data, a historical telemarketing time period and a customer type of each of the historical marketing target customers, wherein the customer type is a customer who has made a transaction or a customer who hasn't made a transaction;
acquiring a customer conversion rate of the telephone sales representative in the historical marketing time period; and
establishing and training the random forest model related to the telephone sales representative based on the personal characteristics data, the historical marketing time period, the customer type and the customer conversion rate of the telephone sales representative in the historical marketing time period of each of the historical marketing target customers.

4. The target customer identification method according to claim 1, wherein the inputting the customer conversion rate of the telephone sales representative in the current working time period and the personal characteristics data of the potential customers into a pre-established random forest model to output product purchase probabilities of the potential customers comprises:
acquiring a pre-established random forest model related to the telephone sales representative, wherein the random forest model comprises a plurality of decision trees;
inputting the customer conversion rate of the telephone sales representative in the current working time period and the personal characteristics data of the potential customers into the random forest model to obtain an output value of each leaf node in each of the decision trees, wherein the output value comprises purchase or no purchase; and
outputting the ratio of the total number of the leaf nodes with the output value of purchase to the total number of leaf nodes in the random forest model as the product purchase probability of the potential customers.

5. The target customer identification method according to claim 4, further comprising:
randomly selecting any number of attribute features in the attribute features of each of the historical marketing target customers when the decision tree generates split nodes, wherein the attribute features comprise the historical marketing time period, the personal characteristics data and the customer conversion rate of the telephone sales representative in the historical marketing time period;
calculating, based on each of the selected attribute features, a first Gini value and a second Gini value of the decision tree before and after splitting, respectively, when each of the selected attribute features serves as the split node; and
respectively obtaining differences between the first Gini value and the second Gini value of the attribute features in the various decision trees, and outputting an average value of the differences of the attribute features in the various decision trees as an influence weight value of the attribute features on the product purchase probability.

6-10. (canceled)

11. An electronic device, comprising a memory and a processor, wherein the memory stores a computer readable instruction executable on the processor, and when executing the computer readable instruction, the computer implements the following steps of:
obtaining personal characteristics data of potential customers;
calculating a customer conversion rate of a telephone sales representative in each of the working time periods according to the total number of customers who have made a transaction and the total number of marketing target customers of the telephone sales representative in each of previously divided working time periods;
inputting the customer conversion rate of the telephone sales representative in the current working time period and the personal characteristics data of the potential customers into a pre-established random forest model to output product purchase probabilities of the potential customers; and
determining a potential customer whose product purchase probability is greater than a preset threshold as a target customer of the telephone sales representative in the current working time period.

12. The electronic device according to claim 11, wherein when executing the computer readable instruction, the processor implements the following steps of:
inputting personal characteristics data of the plurality of the potential customers and the customer conversion rate of the telephone sales representative in the current working time period into the random forest model to respectively output product purchase probabilities of the plurality of potential customers;
sorting the plurality of the potential customers by the product purchase probabilities; and
displaying a sorting result, so that the telephone sales representative performs telemarketing on the potential customers in sequence based on the sorting result.

13. The electronic device according to claim 11, wherein when executing the computer readable instruction, the processor implements the following steps of:
acquiring historical marketing target customers of the telephone sales representative;
obtaining the personal characteristics data, historical marketing time period, and a customer type of each of the historical marketing target customer, wherein the customer type is a customer who has made a transaction or a customer who hasn't made a transaction;
acquiring the customer conversion rate of the telephone sales representative in the historical marketing time period; and
establishing and training the random forest model related to the telephone sales representative based on the personal characteristics data, historical marketing time period, the customer type, and the customer conversion rate of the telephone sales representative in the historical marketing time period of each of the historical marketing target customers.

14. The electronic device according to claim 11, wherein the inputting the customer conversion rate of the telephone sales representative in the current working time period and the personal characteristics data of the potential customers into a pre-established random forest model to output product purchase probabilities of the potential customers comprises:
acquiring a pre-established random forest model related to the telephone sales representative, wherein the random forest model comprises a plurality of decision trees;
inputting the customer conversion rate of the telephone sales representative in the current working time period and the personal characteristics data of the potential customers into the random forest model to obtain an output value of each leaf node in each of the decision trees, wherein the output value comprises purchase or no purchase; and
outputting the ratio of the total number of the leaf nodes with the output value of purchase to the total number of leaf nodes in the random forest model as the product purchase probability of the potential customer.

15. The electronic device according to claim 14, wherein when executing the computer readable instruction, the processor implements the following steps of:
randomly selecting any number of attribute features in the attribute features of each of the historical marketing target customer when the decision trees generate split nodes, wherein the attribute features comprise the historical marketing time period, the personal characteristics data and the customer conversion rate of the telephone sales representative in the historical marketing time period;
calculating, based on each of the selected attribute features, a first Gini value and a second Gini value of the decision tree before and after splitting, respectively, when each of the selected attribute features serves as the split node; and
respectively obtaining differences between the first Gini value and the second Gini value of the attribute features in the various decision trees, and outputting the average value of the differences of the attribute features in the various decision trees as the influence weight value of the attribute features on the product purchase probability.

16. A computer readable storage medium which stores a computer readable instruction, wherein when executing the computer readable instruction, at least one processor implements the following steps of:
obtaining personal characteristics data of potential customers;
calculating a customer conversion rate of a telephone sales representative in each of the working time periods according to the total number of customers who have made a transaction and the total number of marketing target customers of the telephone sales representative in each of previously divided working time periods;
inputting the customer conversion rate of the telephone sales representative in the current working time period and the personal characteristics data of the potential customers into a pre-established random forest model to output product purchase probabilities of the potential customers; and
determining a potential customer whose product purchase probability is greater than a preset threshold as a target customer of the telephone sales representative in the current working time period.

17. The computer readable storage medium according to claim 16, wherein when executing the computer readable instruction, at least one processor implements the following steps of:
inputting personal characteristics data of the plurality of the potential customers and the customer conversion rate of the telephone sales representative in the current working time period into the random forest model to respectively output product purchase probabilities of a plurality of potential customers;
sorting the plurality of potential customers by the product purchase probabilities; and
displaying a sorting result, so that the telephone sales representative performs telemarketing on the potential customers in sequence based on the sorting result.

18. The computer readable storage medium according to claim 16, wherein when executing the computer readable instruction at least one processor implements the following steps of:
acquiring historical marketing target customers of the telephone sales representative;
obtaining the personal characteristics data, historical marketing time period, and a customer type of each of the historical marketing target customers, wherein the customer type is a customer who has made a transaction or a customer who hasn't made a transaction;
acquiring the customer conversion rate of the telephone sales representative in the historical marketing time period; and
establishing and training the random forest model related to the telephone sales representative based on the personal characteristics data, historical marketing time period, the customer type and the customer conversion rate of the telephone sales representative in the historical marketing time period of each of the historical marketing target customers.

19. The computer readable storage medium according to claim 16, wherein the inputting the customer conversion rate of the telephone sales representative in the current working time period and the personal characteristics data of the potential customers into a pre-established random forest model to output product purchase probabilities of the potential customers comprises:
acquiring a pre-established random forest model related to the telephone sales representative, wherein the random forest model comprises a plurality of decision trees;
inputting the customer conversion rate of the telephone sales representative in the current working time period and the personal characteristics data of the potential customers into the random forest model to obtain an output value of each leaf node in each of the decision trees, wherein the output value comprises purchase or no purchase; and
outputting the ratio of the total number of the leaf nodes with the output value of purchase to the total number of leaf nodes in the random forest model with the output value of purchase as the product purchase probability of the potential customer.

20. The computer readable storage medium according to claim 19, wherein when executing the computer readable instruction, at least one processor implements the following steps of:
randomly selecting any number of attribute features in the attribute features of each of the historical marketing target customers when the decision tree generates split nodes, wherein the attribute features comprise the historical marketing time period, the personal characteristics data and the customer conversion rate of the telephone sales representative in the historical marketing time period;
calculating, based on each of the selected attribute features, a first Gini value and a second Gini value of the decision tree before and after splitting, respectively, when each of the selected attribute features serves as the split node; and
respectively obtaining differences between the first Gini value and the second Gini value of the attribute features in the various decision trees, and outputting the average value of the differences of the attribute features in the various decision trees as the influence weight value of the attribute features on the product purchase probability.

21. The target customer identification method according to claim 2, further comprising:
acquiring historical marketing target customers of the telephone sales representative;
obtaining the personal characteristics data, a historical telemarketing time period and a customer type of each of the historical marketing target customers, wherein the customer type is a customer who has made a transaction or a customer who hasn't made a transaction;
acquiring a customer conversion rate of the telephone sales representative in the historical marketing time period; and
establishing and training the random forest model related to the telephone sales representative based on the personal characteristics data, the historical marketing time period, the customer type and the customer conversion rate of the telephone sales representative in the historical marketing time period of each of the historical marketing target customers.

22. The electronic device according to claim 12, wherein when executing the computer readable instruction, the processor implements the following steps of:
acquiring historical marketing target customers of the telephone sales representative;
obtaining the personal characteristics data, historical marketing time period, and a customer type of each of the historical marketing target customer, wherein the customer type is a customer who has made a transaction or a customer who hasn't made a transaction;
acquiring the customer conversion rate of the telephone sales representative in the historical marketing time period; and
establishing and training the random forest model related to the telephone sales representative based on the personal characteristics data, historical marketing time period, the customer type and the customer conversion rate of the telephone sales representative in the historical marketing time period of each of the historical marketing target customers.

23. The computer readable storage medium according to claim 17, wherein when executing the computer readable instruction at least one processor implements the following steps of:
acquiring historical marketing target customers of the telephone sales representative;
obtaining the personal characteristics data, historical marketing time period, and a customer type of each of the historical marketing target customers, wherein the customer type is a customer who has made a transaction or a customer who hasn't made a transaction;
acquiring the customer conversion rate of the telephone sales representative in the historical marketing time period; and
establishing and training the random forest model related to the telephone sales representative based on the personal characteristics data, historical marketing time period, the customer type and the customer conversion rate of the telephone sales representative in the historical marketing time period of each of the historical marketing target customers.
